(19) United States
(12) Patent Application Publication
(10) Pub. No.: US 2019/0226432 A1
(43) Pub. Date: Jul. 25, 2019

(54) INTAKE MANIFOLD FOR INTERNAL COMBUSTION ENGINE

(71) Applicants: TOYOTA JIDOSHA KABUSHIKI KAISHA, Aichi-ken (JP); AISIN SEIKI KABUSHIKI KAISHA, Kariya-shi (JP)

(72) Inventors: Atsushi MIZUGUCHI, Toyota-shi (JP); Ryo IKEGAMI, Kariya-shi (JP)

(21) Appl. No.: 16/239,537

(22) Filed: Jan. 4, 2019

(30) Foreign Application Priority Data
Jan. 24, 2018 (JP) 2018-009715

(51) Int. Cl. F02M 35/10; F02M 35/104

(52) U.S. Cl. CPC F02M 35/10144; F02M 35/10111; F02M 35/104; F02M 35/10321; F02M 35/10216

(57) ABSTRACT

An intake manifold for an internal combustion engine includes a plurality of pieces joined with each other at a linearly extending joint. The pieces include a first piece and a second piece. The joint of the first piece and the second piece includes a first portion and a second portion excluding the first portion. The intake manifold is configured so that the first portion is opposed to a fuel system component of the internal combustion engine when the intake manifold is coupled to the internal combustion engine. A force required to separate the second piece from the first piece is referred to as a joining force. The joining force at the first portion is greater than the joining force at the second portion.

### BACKGROUND ART

The present invention relates to an intake manifold for an internal combustion engine.

Japanese Laid-Open Patent Publication No. 2017-101570 describes an example of an intake manifold formed by joining a plurality of pieces.

In an internal combustion engine that injects fuel into an intake port, fuel system members including a fuel injection valve and a fuel pipe, which supplies the fuel injection valve with fuel, are often located above the intake manifold. When the intake manifold is deformed by a large external force, different pieces of the intake manifold may be separated from each other at portions opposing the fuel system members. This may cause the separated intake manifold pieces to strike the fuel system members.

### SUMMARY

It is an object of the present invention to provide an intake manifold for an internal combustion engine that avoids a situation in which intake manifold pieces strike fuel system members when the intake manifold is deformed.

One aspect of the present invention is an intake manifold for an internal combustion engine. The intake manifold includes a plurality of pieces joined with each other at a linearly extending joint. The plurality of pieces include a first piece and a second piece. The joint of the first piece and the second piece includes a first portion and a second portion excluding the first portion. The intake manifold is configured so that the first portion is opposed to a fuel system component of the internal combustion engine when the intake manifold is coupled to the internal combustion engine. A force required to separate the second piece from the first piece is referred to as a joining force. The joining force at the first portion is greater than the joining force at the second portion.

Other aspects and advantages of the present invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a front view showing one embodiment of an intake manifold;

FIG. 2 is a right view of the intake manifold shown in FIG. 1;

FIG. 3 is an exploded view of the intake manifold shown in FIG. 1;

FIG. 4A is a cross-sectional view of the intake manifold taken along line 4A-4A in FIG. 1;

FIG. 4B is an enlarged view of the region encircled by single-dashed lines in FIG. 4A; and

FIG. 5 is a diagram showing a joint of a first piece in the intake manifold of FIG. 1.

### EMBODIMENTS OF THE INVENTION

One embodiment of an intake manifold for an internal combustion engine will now be described with reference to the drawings. An intake manifold 10 of the present embodiment is a plastic intake manifold coupled to a transverse internal combustion engine, that is, an engine mounted inside the engine compartment of a vehicle in a transverse direction so that the cylinders are lined in the transverse direction of the vehicle.

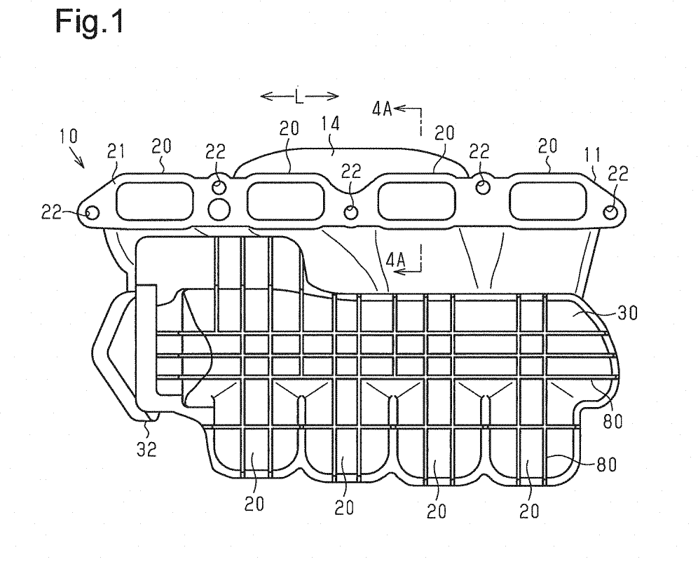

As shown in FIG. 1, the intake manifold 10 includes a surge tank 30. The direction indicated by arrow L in FIG. 1 is the direction in which the cylinders are lined in the internal combustion engine to which the intake manifold 10 is coupled. The surge tank 30 extends in the lined direction of the cylinders. The surge tank 30 has an outer wall including a plurality of ribs 80.

The longitudinal direction of the surge tank 30 corresponds to the lined direction of the cylinders. One longitudinal end of the surge tank 30 includes a throttle flange 32. The throttle flange 32 includes an air inlet through which air is drawn into the surge tank 30. A throttle body including a throttle valve is connected to the throttle flange 32.

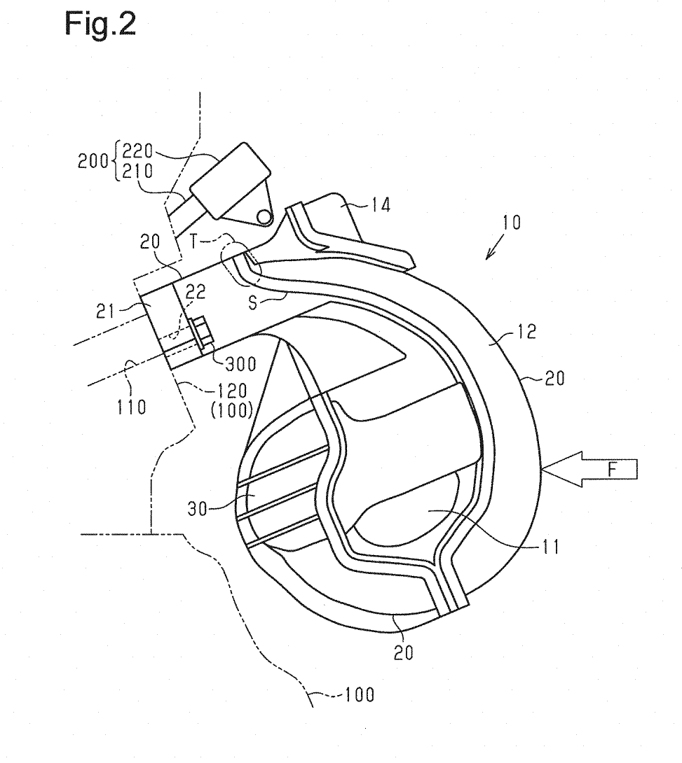

As shown in FIGS. 1 and 2, the intake manifold 10 includes a plurality of branch passages 20, the number of which is the same as the number of cylinders. Each of the branch passages 20 is curved and branched from the surge tank 30 to supply air to the corresponding cylinder of the internal combustion engine 100. The branch passages 20 are arranged next to one another in the lined direction of the cylinders. The intake manifold 10 at the downstream end of the branch passages 20 with respect to the intake air includes a flanged fastening portion 21 fastened to the internal combustion engine 100. The fastening portion 21 includes bolt holes 22 that receive bolts 300. The fastening portion 21 is fastened by bolts to a cylinder head 120 of the internal combustion engine 100 in order to fix the intake manifold 10 to the internal combustion engine 100 in a state in which the branch passages 20 are connected to intake ports 110 formed in the cylinder head 120.

Referring to FIG. 2, in the internal combustion engine 100 to which the intake manifold 10 is coupled, fuel is injected into the intake ports 110. The internal combustion engine 100 includes fuel system members 200 including fuel injection valves 210, which inject fuel into the intake ports 110, and a fuel pipe 220, which extends in the lined direction of the cylinders to distribute and supply fuel to the fuel injection valves 210. The fuel system members 200 are located above the intake manifold 10, more specifically, above the vicinity of the fastening portion 21 of the intake manifold 10.

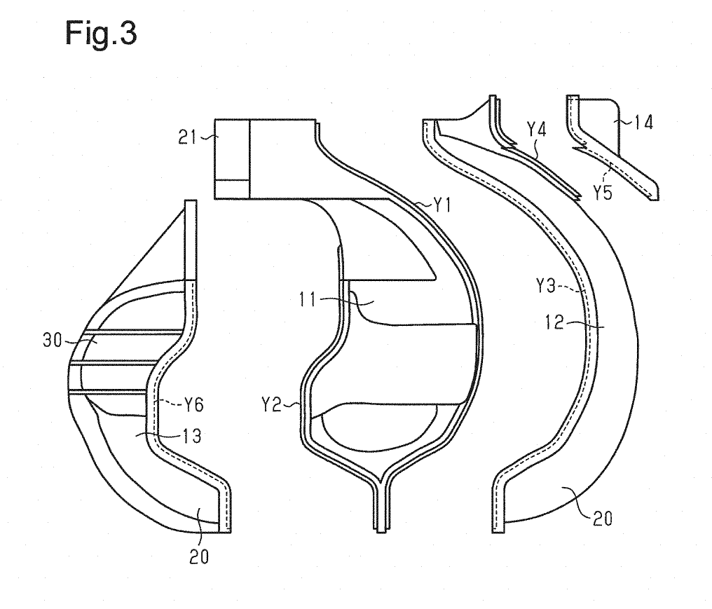

As shown in FIG. 3, the intake manifold 10 includes a plurality of plastic pieces that are integrated with each other. In the present embodiment, the intake manifold 10 includes a first piece 11, a second piece 12, a third piece 13, and a fourth piece 14 that are vibration-welded and integrated with one another.

The first piece 11 includes the throttle flange 32, the fastening portion 21, a first joining portion Y1 that is a projection welded to the second piece 12, and a second joining portion Y2 that is a projection welded to the third piece 13. Further, the first piece 11 forms an inner portion of each branch passage 20 and an upper portion of the surge tank 30.

The second piece 12 forms an outer portion of each branch passage 20. Further, the second piece 12 includes a third joining portion Y3 that is a groove welded with the first joining portion Y1 of the first piece 11. The third joining portion Y3 and the first joining portion Y1 form a joint S of the first piece 11 and the second piece 12.

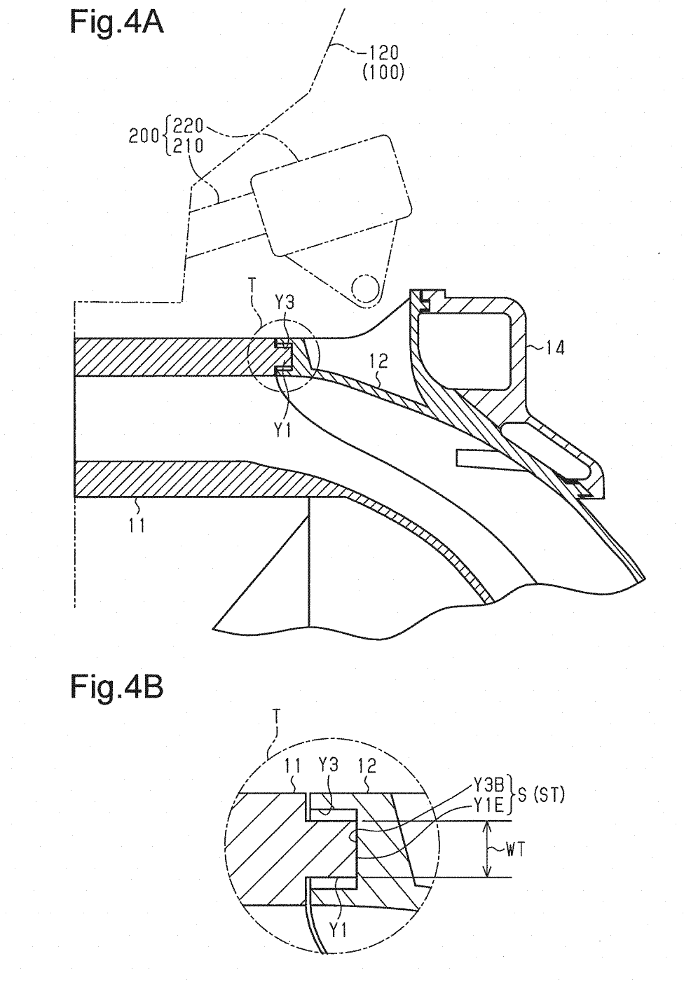

In further detail, with reference to FIGS. 4A and 4B, an end face 1E of the first joining portion Y1, which is a projection, is welded to a bottom wall 3B of the third joining portion Y3, which is a groove. The end face 1E and the bottom wall 3B form the joint S of the first piece 11 and the second piece 12.

The second piece 12 includes a fourth joining portion Y4 that is a projection welded with a fifth joining portion Y5 that is a groove formed in the fourth piece 14. The fourth piece 14 forms an exhaust passage with the second piece 12 to distribute and supply gas used for exhaust gas recirculation (EGR) to the branch passages 20.

The third piece 13 forms a lower portion of the surge tank 30 and the branch passages 20 connected to the surge tank 30. Further, the third piece 13 includes a sixth joining portion Y6 that is a groove welded with the second joining portion Y2 of the first piece 11.

As shown in FIGS. 2 and 3, the second joining portion Y2 of the first piece 11 is located closer to the internal combustion engine 100, and the first joining portion Y1 of the first piece 11 is located farther from the internal combustion engine 100. The third piece 13 is welded to the second joining portion Y2 of the first piece 11, and the first joining portion Y1 of the first piece 11 is welded to the second piece 12. When the internal combustion engine 100 to which the intake manifold 10 is coupled is mounted on the vehicle, among the first to fourth pieces 11 to 14, the second piece 12 is the frontmost piece in the vehicle.

As shown in FIG. 2, in a state in which the intake manifold 10 is coupled to the internal combustion engine 100, the joint S of the first piece 11 and the second piece 12 is partially opposed to the fuel system members 200. In the description hereafter, the portion of the joint S of the first piece 11 and the second piece 12 particularly opposing the fuel system members 200 is referred to as an opposing joint portion ST. More specifically, the portion of the joint S encompassed by single-dashed lines T in FIGS. 2, 4A, 4B, and 5 is referred to as the opposing joint portion ST. The opposing joint portion ST corresponds to a first portion, and a portion of the joint S of the first piece 11 and the second piece 12 excluding the opposing joint portion ST corresponds to a second portion.

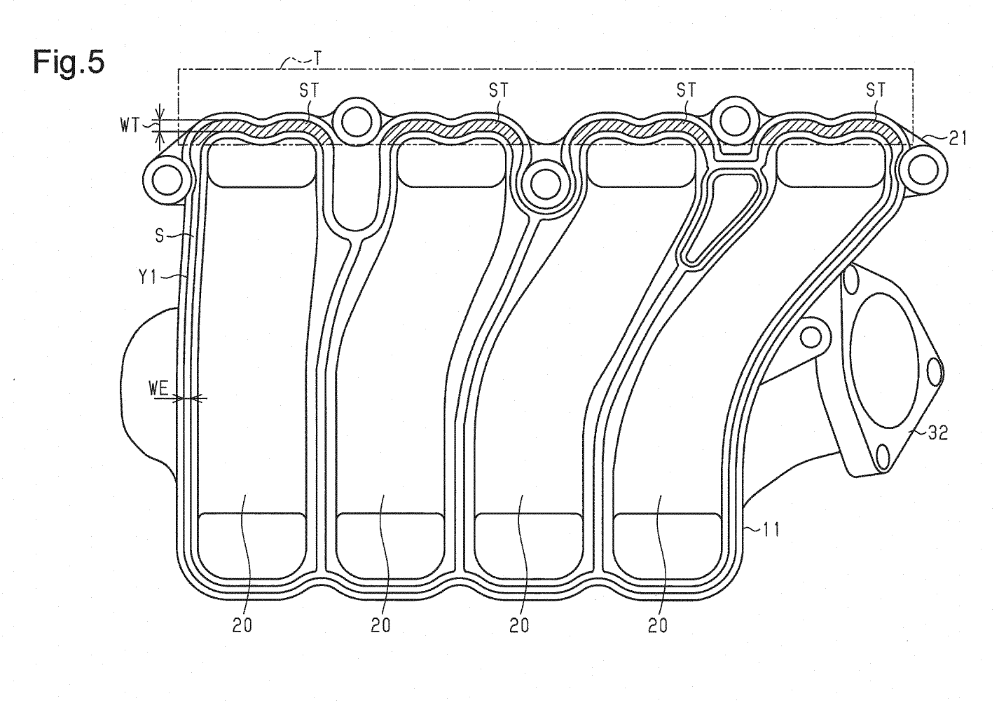

As shown in FIG. 5, the joint S extends linearly. The opposing joint portion ST is the portion of the joint S indicated by hatching lines in FIG. 5. The joining width WT of the opposing joint portion ST is greater than the joining width WE of the portion of the joint S excluding the opposing joint portion ST.

The advantages of the present embodiment will now be described.

(1) As shown in FIG. 2, the intake manifold 10 may be deformed when external force F acting toward the internal combustion engine 100 (e.g., force generated when the front of the vehicle hits an object) is applied to the intake manifold 10. Deformation of the intake manifold 10 may separate the second piece 12 from the first piece 11, which is fixed to the internal combustion engine 100.

The force required to break the joint S is referred to as the joining force. That is, the force required to separate the second piece 12 from the first piece 11 is referred to as the joining force. When the joining force of the joint S is the same throughout the joint S, the portion of the second piece 12 separated from the first piece 11 during deformation of the intake manifold 10 cannot be controlled. When the joining force differs between portions of the joint S, the joint S will easily break at portions where the joining force is small and resist breakage at portions where the joining force is large. In this manner, portions where the intake manifold pieces are easily separated can be controlled by setting different joining forces for different portions.

As shown in FIG. 5, the portion of the joint S opposing the fuel system members 200 is the opposing joint portion ST. The joining width WT of the opposing joint portion ST is greater than the joining width WE of the portion of the joint S excluding the opposing joint portion ST.

In this manner, the joining width of the joint S differs between portions. That is, the joint S has a non-uniform joining width. The area per unit length of the linearly extending joint S is referred to as the unit joining area. The unit joining area of the opposing joint portion ST is greater than the unit joining area of the portion of the joint S excluding the opposing joint portion ST. Thus, the joining force of the opposing joint portion ST is greater than the joining force of the portion of the joint S excluding the opposing joint portion ST.

Accordingly, when external force F is applied to the intake manifold 10, the portion of the joint S excluding the opposing joint portion ST easily breaks, whereas the opposing joint portion ST resists breakage. This avoids a situation in which the second piece 12 strikes the fuel system members 200 when deformation of the intake manifold 10 separates the second piece 12 from the first piece 11.

It should be apparent to those skilled in the art that the present invention may be embodied in many other specific forms without departing from the spirit or scope of the invention. Particularly, it should be understood that the present invention may be embodied in the following forms.

The pieces 11 to 14 do not have to be joined with one another through vibration welding and may be joined with one another through other welding processes.

The pieces 11 to 14 do not have to be joined with one another through welding and may be joined with one another by, for example, an adhesive agent.

The joining width of the joint S differs between portions so that the joining force of the joint S differs between portions. However, other constructions may be used so that the joining force of the joint S differs between portions. For example, when using an adhesive agent to join the first piece 11 and the second piece 12, the adhesive agent applied to the opposing joint portion ST may have a stronger adhesive force than the adhesive force applied to the portion of the joint S excluding the opposing joint portion ST.

The pieces 11 to 14 are formed from plastic but may be formed from other materials.

The location where the intake manifold 10 is separated into pieces (location of joint) may be changed.

The number of pieces forming the intake manifold 10 may be changed.

The present examples and embodiments are to be considered as illustrative and not restrictive, and the invention is not to be limited to the details given herein, but may be modified within the scope and equivalence of the appended claims.

1. An intake manifold for an internal combustion engine, the intake manifold comprising:
a plurality of pieces joined with each other at a linearly extending joint, wherein
the plurality of pieces include a first piece and a second piece,
the joint of the first piece and the second piece includes a first portion and a second portion excluding the first portion,
the intake manifold is configured so that the first portion is opposed to a fuel system component of the internal combustion engine when the intake manifold is coupled to the internal combustion engine,
a force required to separate the second piece from the first piece is referred to as a joining force, and
the joining force at the first portion is greater than the joining force at the second portion.

2. The intake manifold according to claim 1, wherein the first portion has a greater joining width than the second portion.

3. The intake manifold according to claim 1, wherein the pieces are formed from plastic and welded to each other at the joint.
